(19) United States
(12) Patent Application Publication
(10) Pub. No.: US 2015/0361233 A1
(43) Pub. Date: Dec. 17, 2015

(54) SEBUM ABSORPTION/DIFFUSION FILM

(71) Applicants: KABUSHIKI KAISHA NITOMS, Tokyo (JP); NITTO DENKO CORPORATION, Ibaraki-shi, Osaka (JP)

(72) Inventors: Teiji SAKASHITA, Tokyo (JP); Satoshi TAGUCHI, Tokyo (JP); Yumi KAWAI, Tokyo (JP); Aya NAGATOMO, Ibaraki-shi (JP)

(21) Appl. No.: 14/762,675

(22) PCT Filed: Jan. 16, 2014
(86) PCT No.: PCT/JP2014/050663

§ 371 Date: Jul. 22, 2015

(30) Foreign Application Priority Data
Jan. 25, 2013 (JP) 2013-012472

(51) Int. Cl. C08J 5/18; G06F 3/041; C08K 5/11

(52) U.S. Cl. CPC C08J 5/18; C08K 5/11; G06F 3/041; C08J 2333/08; C08J 2333/00

(57) ABSTRACT

This invention provides a film having a novel function such that the film itself eliminates sebum dirt adsorbed on the film surface. The sebum absorption/diffusion film provided by the present invention is used for covering a surface of an article to prevent adsorption of sebum to the surface. It is characterized by absorbing sebum adsorbed on the film surface into the film and allowing it to diffuse inside the film.

### TECHNICAL FIELD

The present invention relates to a sebum absorption/diffusion film applied to an article used in an embodiment to attract sebum. In particular, it relates to a sebum absorption/diffusion film to cover a touch panel surface in a portable device such as a tablet terminal, smartphone and the like. The present application claims priority based on Japanese Patent Application No. 2013-012472 filed on Jan. 25, 2013 and the entire contents thereof are incorporated herein by reference.

### BACKGROUND ART

In portable devices such as mobile terminals—for example, portable personal computers (PCs) such as notebook PCs, etc.; tablet terminals such as electronic books, etc.; mobile phones such as smartphones, etc.; mobile gaming devices; various types of PDA (personal digital assistant); and the like, because of the portability, the surfaces are likely to attract dirt such as finger marks, costmetics, sebum and the like. In particular, sebum is harder to be wiped off as compared with dust and remains in forms of fingerprints, etc., on the surfaces, being unsightly. Depending on the amount of sebum dirt adsorbed thereon, it might give a filthy impression. When the sebum is adsorbed on a display (display formed of a liquid crystal panel or an organic EL pane) in a portable device, there are issues such that the displayed contents become hard to see and the visibility is reduced. In particular, recently wide-spread touch-screen portable devices are operated with a direct finger touch by a user to the display/input portion in which the display functions also as an input device, and thus are more likely to attract sebum dirt, making the issues significant. The sebum marks are not limited to portable devices, but can be seen on doorknobs, hanging straps, showcases and so on.

To deal with the sebum dirt as described above, for instance, Patent Document 1 suggests a technique such that the surface properties of a film are adjusted to make sebum dirt such as fingerprints, etc., on the film surface less notable. However, the conventional technique does not prevent adsorption or accumulation (remaining) of dirt such as fingerprints, etc. Thus, the amount of adsorbed sebum increases with time, and degradation of the exterior and lowering of the visibility cannot be avoided.

### CITATION LIST

### Patent Literature

[Patent Document 1] Japanese Patent Application Publication No. 2004-361835

### SUMMARY OF INVENTION

### Technical Problem

The present invention has been made to solve the conventional problem. An objective thereof is to provide a film having a novel function such that the film itself eliminates sebum dirt adsorbed on the film surface.

### Solution to Problem

To achieve the objective, the present invention provides a film (sebum absorption/diffusion film) used for covering a surface of an article to prevent adsorption of sebum to the surface. The film is characterized by absorbing sebum adsorbed on the film surface into the film and allowing it to diffuse inside the film. According to such a sebum absorption/diffusion film, the sebum adsorbed on the film surface is absorbed into the film and diffused inside the film. Accordingly, the amount of sebum on the film surface decreases, eventually to an almost invisible level. Typically, the film surface can be renewed to the state before the sebum adsorption. In summary, the present invention provides a sebum absorption/diffusion film that eliminates sebum dirt adsorbed on the film surface by absorbing it into itself. The sebum absorption/diffusion film absorbs and diffuses sebum in particular, but does not exclude absorption and diffusion of non-sebum dirt (e.g. sweat, cosmetics, etc.)

In a preferable embodiment disclosed herein, the film has a haze value of 10% or lower. A film having such a low haze value is highly transparent. Thus, it is preferably used, for instance, for a purpose requiring viewing of the adherend, such as a display formed of a liquid crystal panel or organic EL panel, a showcase, and the like.

In a preferable embodiment of the art disclosed herein, the sebum absorption/diffusion film comprises an acrylic resin. The acrylic resin is preferably a thermoplastic acrylic resin. Such a composition is likely to provide a sebum absorbing/diffusing ability to the film and has an excellent film-forming ability. In another embodiment, the acrylic resin is preferably a crosslinked acrylic resin. This composition is also likely to provide a sebum absorbing/diffusing ability, and because it is highly cohesive, it may yield a surface with a great feel to the touch. The film preferably comprises a plasticizer at a ratio of 5 to 150 parts by mass relative to 100 parts by mass of the acrylic resin. Such a composition is likely to bring about a film having an excellent sebum absorbing/diffusing ability.

A preferable embodiment of the film disclosed herein is used for protecting a display in a portable device. By applying the film disclosed herein to the portable device's display for protection purposes, the sebum absorption/diffusion effect of the film is preferably exhibited, making it possible to avoid the trouble of causing the displayed contents poorly visible due to sebum adsorption.

The present invention also provides an article having a surface covered with a sebum absorption/diffusion film disclosed herein. Because the surface of the article is covered with the sebum absorption/diffusion film, the sebum dirt adsorbed on the film surface can be reduced with time, making the surface more visibly attractive. The present invention further provides a portable device whose surface having a touch panel display/input portion is covered with a sebum absorption/diffusion film disclosed herein. The touch panel display/input portion can be operated with a direct finger touch by a user. Thus, sebum dirt is easily adsorbed to the display, giving rise to relatively great disadvantages. To a portable device having such a touch panel display/input portion, the sebum absorption/diffusion film disclosed herein can be preferably applied.

### BRIEF DESCRIPTION OF DRAWINGS

FIG. 1 shows a cross-sectional view schematically illustration the sebum absorption/diffusion film according to an embodiment.

FIG. 2 shows a diagram schematically illustrating the sebum absorption/diffusion effect of the sebum absorption/diffusion film according to an embodiment.

FIG. 3 shows a perspective view schematically illustrating an example of application of the sebum absorption/diffusion film according to an embodiment.

FIG. 4 shows an image of the surface of a tablet terminal immediately after sebum adsorption in a test on the sebum absorption/diffusion ability.

FIG. 5 shows an image of the surface of the tablet terminal after 25 hours from sebum adsorption in the test on the sebum absorption/diffusion ability.

FIG. 6 shows comparative images illustrating changes in states of adsorption of sebum from the initial time of adsorption to 25 hours from the adsorption in Examples 1 to 4.

FIG. 7 shows comparative images illustrating the changes in states of adsorption of a sebum substitute from the initial time of adsorption to 25 hours from the adsorption in Examples 1 to 4.

FIG. 8 shows comparative images illustrating changes in states of adsorption of sebum from the initial time of adsorption to 25 hours from the adsorption in Examples 5 to 8.

FIG. 9 shows comparative images illustrating changes in states of adsorption of a sebum substitute from the initial time of adsorption to 25 hours from the adsorption in Examples 5 to 8.

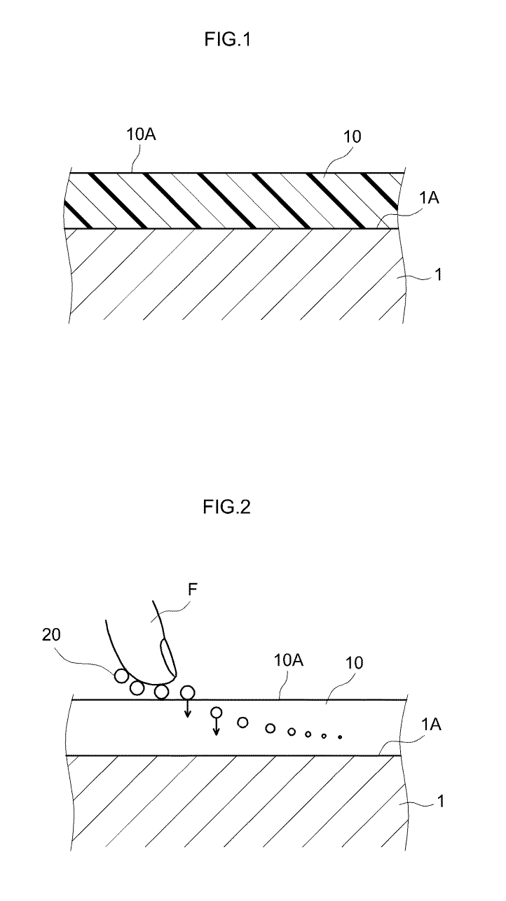

### DESCRIPTION OF EMBODIMENTS

Preferred embodiments of the present invention are described below. Matters necessary to practice this invention other than those specifically referred to in this description may be understood as design matters to a person of ordinary skill in the art based on the conventional art in the pertinent field. The present invention can be practiced based on the contents disclosed in this description and technical common knowledge in the subject field.

The sebum absorption/diffusion film (or simply film hereinafter) disclosed herein is used for covering a surface of an article to prevent adsorption of sebum to the surface. A film 10 according to a preferable embodiment is a single-layer film and is used for covering a surface 1A in an article 1 such as a portable device, etc. Film 10 covers the surface 1A of article 1 to prevent the surface 1A from adsorbing dirt such as sebum and the like. Film 10 is adhered via releasable, weak stick (e.g. pressure-sensitive adhesion) to the surface 1A in article 1. A surface 10A of film 10 is exposed to the outer surface. Because of this, when a user holds the article 1, for instance, by bare hand, sebum of the user will be adsorbed not on the surface 1A in article 1, but on the surface 10A of film 10. Film 10 has a property (sebum absorbing/diffusing property) to absorb, for instance, sebum (not shown in the drawing) adsorbed on the surface 10A of film 10 in the aforementioned manner and allows it to diffuse inside the film 10.

The sebum absorbing/diffusing ability is described with reference to FIG. 2. As schematically illustrated in FIG. 2, when a fingertip F of a user (not shown) touches the surface 10A of film 10 covering the surface 1A of article 1, sebum 20 present on fingertip F is transferred to the surface 10A of film 10 and adsorbed on the surface 10A. This operation is repeated during the use of article 1, etc., a large amount of sebum 20 is adsorbed on the surface 10A and remains thereon as fingerprints, etc., to turn the surface unsightly. Wiping sebum 20 adsorbed on the surface 10A of film 10 in such a manner with waste cloth, etc., is troublesome since the wiping causes the sebum to spread out and its elimination to a satisfactory level is not easy. For instance, when the surface 1A is a display (display formed of a liquid crystal panel or organic EL panel) in a portable device, the contents shown on the display may become hard to see. In other words, the visibility may decrease. In particular, when the surface 1A is a touch panel in a portable device, as it can be frequently touched with fingertip F, a considerable amount of sebum 20 may be adsorbed.

The film 10 disclosed herein, however, has a sebum absorbing/diffusing ability. Thus, sebum 20 adsorbed on the surface 10A of film 10 is absorbed into film 10 as schematically illustrated in FIG. 2. It is then further diffused insdie the film 10. Thus, the sebum quantity on the surface 10A of film 10 is reduced by an amount absorbed into the film 10. Eventually, sebum 20 becomes almost invisible on the surface 10A of film 10. Accordingly, the surface 10A of film 10 can be renewed to the state before the sebum adsorption. When the sebum absorption/diffusion film is a transparent film adhered, for instance, to a touch panel surface, a question may arise regarding the sebum absorption causing a reduction of visibility (transparency) of the film itself. However, such a phenomenon has not been observed so far. While it is unnecessary to reveal the reason for this, for instance, it can be thought that a typical amount of sebum adsorbed on the film surface does not lead to a reduction in the transparency of the film. In other words, in view of the transparency, a large allowance of the film for sebum absorption is a possibility. It can be also thought that because of the very nature of sebum absorbed into the film, the transparency of the film is not relatively impaired.

In the embodiment above, the film is directly placed on the article's surface, but it is not limited to this. In accordance with the purpose, between the film and article's surface, there may be placed, for instance, an adhesive layer or anchor layer, substrate (preferably a sheet of transparent substrate such as a polyethylene terephthalate (PET) sheet, etc.), and the like. The film is not limited to a single-layer structure and can be a multi-layer film having a multi-layer structure (e.g. a two-layer, three-layer or higher multi-layer structure) formed of several films (typically sebum absorption/diffusion films) having different compositions. It can also be formed of, for instance, a substrate (preferably a sheet of transparent substrate such as a PET sheet) and a film (sebum absorption/diffusion film) disclosed herein layered on one or each face thereof.

At least a first face (preferably the face opposing the article) of the film disclosed herein preferably exhibits an adhesive strength of 0.001 N/25 mm or greater as a measured value based on the 180° peel test specified in JIS Z0237. This allows for preferable adhesion of the film to the article. The adhesive strength is more preferably 0.01 N/25 mm or greater, yet more preferably 0.02 N/25 mm or greater, or particularly preferably 0.05 N/25 mm or greater. From the standpoint of the releasing ability after achieving the purpose of use and workability during subsequent adhesion, the adhesive strength is preferably less than 1 N/25 mm. The adhesive strength is more preferably 0.5 N/25 mm or less, yet more preferably 0.3 N/25 mm or less, or particularly preferably 0.1 N/25 mm or less. The adhesive strength can be essentially 0 N/25 mm.

The adhesive strength on the second face (preferably the face exposed to the outer surface) of the film can be similar to the adhesive strength of the first face. From the standpoint of the feel to the touch, it preferably exhibits a lower adhesive strength than the first face. For instance, the adhesive strength of the second face can be 0.02 N/25 mm or less (e.g. 0.01 N/25 mm or less, typically 0.005 N/25 mm or less).

The adhesive strength is measured according to the following procedures: The film is cut to a rectangular sheet to prepare a test piece. The test piece preferably has a length of about 100 mm to 200 mm and a width of about 15 mm to 30 mm. When the width is not 25 mm, the value in N/25 mm can be determined (by conversion) based on the ratio of actual width to 25 mm. The test piece can be backed on the face opposite the face to be measured with a polyethylene terephthalate (PET) film of about 25 μm in thickness. The prepared test piece is adhered over the face to be measured to a stainless steel (SUS304) plate with a 2 kg roller moved back and forth once. This is stored in an environment at 23° C. and 50% RH for 30 minutes. Based on JIS Z0237, using a tensile tester, in an environment at 23° C. and 50% RH, at a peel angle of 180° and at a tensile speed of 300 mm/min, the adhesive strength (N/25 mm) is measured. The tensile tester is not particularly limited and a heretofore known tensile tester can be used. For instance, measurements can be made with trade name “TENSILON” available from Shimadzu Corporation.

The film disclosed herein preferably has a haze value of 15% or lower. A film having such a low haze value is highly transparent. Thus, it is preferably used, for instance, for a purpose requiring viewing of the adherend, such as a display formed of a liquid crystal panel or organic EL panel, a showcase, and the like. The haze value is more preferably 10% or lower, yet more preferably 5% or lower, or particularly preferably 3% or lower. The term “haze value (%)” herein refers to the ratio of diffuse light transmittance to total light transmittance when the subject film is irradiated with visible light. The haze value Th (%) can be represented by an equation: Th+Td/Tt (Td is the scattering transmittance and Tt is the total light transmittance herein). The haze value can be measured, using a heretofore known haze meter, based on JIS K7136. As the haze meter, for instance, “HAZEMETER HM-150” available from Murakami Color Research Laboratory Co., Ltd. can be used. A similar method is used in the working examples described later.

The film disclosed herein can be formed from a resin composition such as an acrylic resin composition, rubber composition (e.g. natural rubber composition), urethane resin composition, silicone resin composition and so on. From the standpoint of the adhesion to the adherend and cost, the film is preferably formed from a rubber composition or an acrylic resin composition. From the standpoint of the sebum absorbing/diffusing ability, it is preferably formed from an acrylic resin composition.

The film disclosed herein can be typically a viscoelastic body. It is preferably a viscoelastic body that exhibits viscoelastic characteristics at least at normal temperature (typically 23° C., preferably 0° C. to 40° C., more preferably −20° C. to 50° C.). Such a viscoelastic body is likely to form a sebum absorption/diffusion film. From the standpoint of the sebum absorbing/diffusing ability, it is more preferable that the viscoelastic body has a storage modulus (G′) and a loss modulus (G″) satisfying G′>G″ at the temperature (typically 23° C., preferably 0° C. to 40° C., more preferably −20° C. to 50° C.). From a similar standpoint, the viscoelastic body has a storage modulus of preferably 1 MPa or less, or more preferably 0.9 MPa or less. The storage modulus (G′) and loss modulus (G″) can be determined by measuring values in a prescribed temperature range (e.g. −70° C. to 150° C.) at a heating rate of 5° C./min while applying a shear strain to a measurement sample (e.g. a cutout of 7.9 mm diameter) at a frequency of 1 Hz using a heretofore known rheometer (trade name “ARES” available from Rheometrics Scientific, Inc.).

In particular, from the standpoint of the sebum absorbing/diffusing ability, the viscoelastic body preferably comprises an acrylic resin as a base polymer (a primary component among polymers, a primary film component). The acrylic resin is also highly transparent. The acrylic resin can be synthesized from starting monomer(s) comprising, as the primary monomer, an alkyl (meth)acrylate having an alkyl group. The primary monomer herein refers to a monomer that accounts for 50% by mass or more of all the monomers. In the present description, the term “(meth)acrylate” comprehensively means acrylate and methacrylate. Similarly, the terms “(meth)acryloyl” and “(meth)acryl” comprehensively mean acryloyl and methacryloyl, and acryl and methacryl, respectively.

As the alkyl (meth)acrylate, for instance, a compound represented by a formula can be preferably used:

CH₂═CR¹COOR²

Herein, R¹ in the formula is a hydrogen atom or a methyl group. R² is an alkyl group having 1 to 20 carbon atoms (hereinafter, such a range of the number of carbon atoms may be indicated as “C₁₋₂₀”). From the standpoint of the storage elastic modulus of the viscoelastic body, etc., an alkyl (meth)acrylate having a C₁₋₁₄ (e.g., C₁₋₁₀) alkyl group is preferable. The alkyl group may be linear or branched.

Examples of the alkyl (meth)acrylate having a C₁₋₂₀ alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isoamyl (meth)acrylate, neopentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, bornyl (meth)acrylate, isobornyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. These alkyl (meth)acrylates may be used singly as one species or in a combination of two or more species. In particular, an alkyl (meth)acrylate having a C₄₋₉ alkyl group is preferable. Preferable examples include n-butyl acrylate (BA), 2-ethylhexyl acrylate (2EHA) and isononyl acrylate. Among these, BA and 2EHA are more preferable.

The ratio of primary monomer to all the monomers is preferably 60% by mass or higher, more preferably 80% by mass or higher, or yet more preferably 90% by mass or higher. The upper Emit of the primary monomer ratio is not particularly limited. It is preferably 99% by mass or less (e.g. 98% by mass or less, typically 95% by mass or less). The acrylic resin can be a polymerization product of essentially just the primary monomer.

To improve various properties such as the ease of release, etc., the starting monomers used in polymerization of the acrylic resin may comprise, in addition to the primary monomer, a secondary monomer that can be copolymerized with the primary monomer. The secondary monomer encompasses not only a monomer, but also an oligomer. As such a secondary monomer, a monomer having a functional group (or “functional group-containing monomer” hereinafter) can be cited. The functional group-containing monomer can be added to incorporate crosslinking points into the acrylic resin to increase the cohesive strength thereof. Examples of such a functional group-containing monomer include carboxyl-group-containing monomers, acid-anhydride-group-containing monomers, hydroxyl-group-containing monomers, amide-group-containing monomers, amino-group-containing monomers, epoxy-group (glycidyl group)-containing monomers, alkoxy-group-containing monomers, and alkoxysilyl-group-containing monomers. These can be used as a single kind alone, or in combination of two or more kinds. Among these, functional group-containing monomers having a functional group of carboxyl group, hydroxyl group, epoxy group, etc. are more preferable, and carboxyl-group-containing monomers and hydroxyl-group-containing monomers are yet more preferable because they can preferably introduce crosslinking points into the acrylic resin and achieve an even higher cohesive strength in the acrylic resin.

Examples of a carboxyl-group-containing monomer include ethylenic unsaturated monocarboxylic acids such as acrylic acid, methacrylic acid, crotonic acid, carboxyethyl (meth)acrylate, carboxypentyl (meth)acrylate, etc.; ethylenic unsaturated dicarboxylic acids such as itaconic acid, maleic acid, fumaric acid, citraconic acid, etc.; and the like. Among these, acrylic acid and/or methacrylic acid are preferable, and acrylic acid is especially preferable.

Examples of an acid-anhydride-group-containing monomers include acid anhydrides of the ethylenic unsaturated dicarboxylic acids listed above such as maleic acid anhydride, itaconic acid anhydride, etc.; and the like.

Examples of a hydroxyl-group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, etc.; unsaturated alcohols such as N-methylol(meth)acrylamide, vinyl alcohol, allyl alcohol, 2-hydroxyethyl vinyl ether, 4-hydroxybutyl vinyl ether, diethylene glycol monovinyl ether, etc.; and the Eke.

Examples of an amide-group-containing monomer include (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide, and the like.

Examples of an amino-group-containing monomer include aminoethyl (meth)acrylate, N,N-dimethylaminoethyl (meth)acrylate, t-butylaminoethyl (meth)acrylate, and the like.

Examples of an epoxy-group (glycidyl group)-containing monomer include glycidyl (meth)acrylate, methylglycidyl (meth)acrylate, allyl glycidyl ether, and the like.

Examples of an alkoxy-group-containing monomer include methoxyethyl (meth)acrylate, ethoxyethyl (meth)acrylate, and the like.

Examples of an alkoxysilyl-group-containing monomer include 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane, and the like.

When an aforementioned functional group-containing monomer is used as a monomer constituting the acrylic resin, the functional group-containing monomer (preferably a carboxyl group-containing monomer) is preferably added at 1 to 10% by mass (e.g., 2 to 8% by mass, typically 3 to 7% by mass) of all the monomers.

To increase the cohesive strength of the acrylic resin, etc., another monomer besides the functional-group-containing monomer can be included as a secondary monomer. Examples of such a monomer include vinyl-ester-based monomers such as vinyl acetate, vinyl propionate, etc.; aromatic vinyl compounds such as styrene, substituted styrenes (α-methylstyrene, etc.), vinyl toluene, etc.; and the like.

The method for polymerizing the monomer or a monomer mixture is not particularly limited, and a general polymerization method heretofore known can be employed. Examples of such a polymerization method include solution polymerization, emulsion polymerization, bulk polymerization, and suspension polymerization. Among these, solution polymerization is preferable. The embodiment of the polymerization is not particularly limited and can be carried out with suitable selection of a heretofore known monomer supply method, polymerization conditions (temperature, time, pressure, etc.), and other components (polymerization initiator, surfactant, etc.) used besides the monomer. For instance, as the monomer supply method, the monomer mixture can be supplied to a reaction vessel all at once (all-at-once supply), or gradually supplied dropwise (continuous supply), or the mixture can be divided in several portions and each portion can be supplied at a prescribed time interval (portionwise supply). The monomer or the monomer mixture can be supplied as a solution or a dispersion containing part or all thereof dissolved in a solvent or emulsified in water.

The polymerization initiator is not particularly limited. Examples include azo-based initiators such as 2,2′-azobisisobutylonitrile, etc.; peroxide-based initiators such as benzoyl peroxide, etc.; substituted ethane-based initiators such as phenyl-substituted ethane, etc.; redox-based initiators combining a peroxide and a reducing agent such as a combination of a peroxide and sodium ascorbate, etc.; and the like. The amount of polymerization initiator used can be suitably selected in accordance with the type of polymerization initiator, types of monomers (composition of the monomer mixture) and so on. It is usually suitably selected from a range of, for instance, about 0.005 part by mass to 1 part by mass, relative to 100 parts by mass of all the monomers. The polymerization temperature can be, for example, around 20° C. to 100° C. (typically 40° C. to 80° C.).

A crosslinking agent is preferably added to the resin composition. This increases the cohesion to make the film surface smooth to the touch. Preferable examples of a crosslinking agent for an acrylic resin include organometallic salts such as zinc stearate, barium stearate, etc.; epoxy-based crosslinking agents; isocyanate-based crosslinking agents; and the like. Oxazoline-based crosslinking agents, aziridine-based crosslinking agents, metal-chelate-based crosslinking agents, and melamine-based crosslinking agents can also be used. These crosslinking agents can be used singly as one species or as two or more species together. Among these, epoxy-based crosslinking agents and isocyanate-based crosslinking agents are preferable because they can be preferably crosslinked to carboxyl groups and are likely to produce good maneuverability (typically easy-release nature) and even good acid resistance as well. Combined use of an epoxy-based crosslinking agent and an isocyanate-based crosslinking agent is particularly preferable. The amount of crosslinking agent added is not particularly limited. In order to achieve desirable adhesive strength and feel to the touch, it can be about 0.01 to 10 parts by mass (e.g. 0.05 to 5 parts by mass, typically 0.1 to 5 parts by mass) relative to 100 parts by mass of the base polymer (e.g. an acrylic resin). When an epoxy-based crosslinking agent (C_{E}) and an isocyanate-based crosslinking agent (C_{I}) are used together, their mass ratio value (C_{E}/C_{I}) is preferably 0.01 to 1 (e.g. 0.05 to 0.5, typically 0.1 to 0.4).

When a solvent-based resin composition is used, preferable examples of a solvent for use include aliphatic hydrocarbons such as hexane, heptane, mineral spirit, etc.; alicyclic hydrocarbons such as cyclohexane, etc.; aromatic hydrocarbons such as toluene, xylene, solvent naphtha, tetralin, dipentene, etc.; alcohols such as butyl alcohol, isobutyl alcohol, cyclohexyl alcohol, 2-methylcyclohexyl alcohol, tridecyl alcohol, etc.; esters such as methyl acetate, ethyl acetate, isopropyl acetate, butyl acetate, etc.; ketones such as acetone, methyl ethyl ketone, etc.

The molecular weight (Mw: weight average molecular weight) of the base polymer (e.g. an acrylic resin) to be used (synthesized) is not particularly limited, but a polymer (e.g., an acrylic resin) having a weight average molecular weight (Mw) of approximately 30×10⁴ to 100×10⁴ can be used preferably.

The acrylic resin constituting the film in the art disclosed herein can be a thermoplastic polymer. A typical example thereof is an acrylic block copolymer. Can be preferably used an acrylic block copolymer comprising at least one acrylate block (which hereinafter may be referred to as an Ac block) and at least one methacrylate block (which hereinafter may be referred to as an MAc block). For instance, preferable is a block copolymer having a structure in which Ac blocks and MAc blocks are positioned alternately. The total number of Ac blocks and MAc blocks is preferably 3 or larger (e.g., 3 to 5).

In typical, the Ac block preferably comprises an alkyl acrylate as the primary monomer (i.e. the component that accounts for 50% by mass or more among the block-constituting monomeric units). Of the monomeric units, 75% by mass or more (e.g. 90% by mass or more) can be an alkyl acrylate. In a preferable embodiment, the monomeric units constituting the Ac block in the acrylic block copolymer (in an acrylic block copolymer comprising two or more Ac blocks, possibly at least one of the Ac blocks or all the Ac blocks) essentially consist of one, two or more species (typically one species) of alkyl acrylate. Alternatively, the Ac block may be a copolymer of an alkyl acrylate and another monomer (e.g. an alkyl methacrylate, etc.).

Examples of the Ac block-constituting alkyl acrylate include methyl acrylate, ethyl acrylate, n-propyl acrylate, isopropyl acrylate, n-butyl acrylate (BA), isobutyl acrylate, tert-butyl acrylate, n-pentyl acrylate, n-hexyl acrylate, n-heptyl acrylate, n-octyl acrylate, 2-ethylhexyl acrylate (2EHA), nonyl acrylate, isononyl acrylate, decyl acrylate, dodecyl acrylate, stearyl acrylate, etc. For example, a constitution where the Ac block-constituting monomers essentially consist of BA alone, 2EHA alone, or both BA and 2EHA can be preferably used.

It is typically preferable that the MAc block comprises an alkyl methacrylate as the primary monomer. Of all the monomers constituting the MAc, 75% by mass or more (e.g. 90% by mass or more) can be an alkyl methacrylate. In a preferable embodiment, the monomeric units constituting the MAc block (in an acrylic block copolymer comprising two or more MAc blocks, possibly at least one of the MAc blocks or all the MAc blocks) contained in the acrylic block copolymer essentially consist of only one, two or more species (typically one species) of alkyl methacrylate. Alternatively, the MAc block may be a copolymer of an alkyl methacrylate and another monomer (e.g., an alkyl acrylate).

The alkyl methacrylate constituting the MAc block may be an alkyl methacrylate whose alkyl group has 1 to 20 (preferably 1 to 14) carbon atoms. Specific examples thereof include methyl methacrylate, ethyl methacrylate, n-propyl methacrylate, isopropyl methacrylate, n-butyl methacrylate, isobutyl methacrylate, tert-butyl methacrylate, n-pentyl methacrylate, n-hexyl methacrylate, n-heptyl methacrylate, n-octyl methacrylate, 2-ethylhexyl methacrylate, nonyl methacrylate, isononyl methacrylate, decyl methacrylate, dodecyl methacrylate, stearyl methacrylate, etc.

In a preferable embodiment, of the monomers constituting the MAc block, 50% by mass or greater (or 75% by mass or greater, or essentially all) is an alkyl methacrylate having an alkyl group with 1 to 4 carbon atoms. Especially preferable alkyl methacrylates include methyl methacrylate (MMA) and ethyl methacrylate (EMA). For example, the monomers preferably employed may consist essentially of MMA alone, EMA alone, both MMA and EMA, or the like.

The acrylic block copolymer in the art disclosed herein may be a copolymer comprising A blocks and B blocks positioned alternately such as type AB, type ABA, type ABAB, type ABABA, etc., with the A block having been formed of a polymer having a rigid structure with excellent cohesive strength and elasticity, and the B block having been formed of a polymer having a flexible structure with excellent viscosity. A film comprising as its base polymer an acrylic block copolymer having such a structure may form a viscoelastic film combining cohesive strength and elasticity as well as viscosity at high levels. A viscoelastic body having such a composition can be preferably used as a hot melt viscoelastic body. An acrylic block copolymer (such as type ABA, type ABABA, etc.) having a structure with A blocks at both termini of the molecule can be preferably used. An acrylic block copolymer having such a structure is preferable because it is likely to have a good balance of cohesion and thermoplasticity.

When the acrylic block copolymer comprises two or more A blocks, the compositions, molecular weights (polymerization degrees), structures, etc., of these A blocks can be the same with or different from each other. When the acrylic block copolymer comprises two or more B blocks, the same is true with the B blocks.

As the A block, can be preferably used an MAc block as those described above. As the B block, can be preferably used an Ac block as those described above. In a preferable embodiment, the acrylic block copolymer is a triblock copolymer having a structure of MAc-Ac-MAc (type ABA). For instance, can be preferably used a triblock copolymer with two MAc blocks having essentially identical monomer compositions.

The ratio of mass of MAc block (when two or more MAc blocks are contained, their total mass) to mass of Ac block (when two or more Ac blocks are contained, their total mass) in the acrylic block copolymer is not particularly limited, but can be preferably in a range such that the mass ratio MAc block/Ac block is 4/96 to 90/10 (usually 7/93 to 80/20, preferably 10/90 to 70/30, e.g., 20/80 to 50/50). At a large MAc block ratio, there is a tendency for reduced adhesive strength, allowing for easy release. At a large Ac block ratio, there is a tendency for an increased sebum absorbing/diffusing ability.

As the acrylic block copolymer, in usual, can be suitably used an acrylic block copolymer having a weight average molecular weight (Mw) of about 3×10⁴ to 30×10⁴. The acrylic block copolymer has a Mw of preferably about 3.5×10⁴ to 25×10⁴ or more preferably about 4×10⁴ to 20×10⁴ (e.g., 5×10⁴ to 15×10⁴). Too small a Mw of the acrylic Nock copolymer may decrease the cohesion or lower the ease of release. Too large a Mw tends to lead to insufficient thermoplasticity of the acrylic block copolymer. The Mw of the acrylic block copolymer described here refers to a value based on standard polystyrene that is determined by gel permeation chromatography (GPC) with respect to a sample prepared by dissolving the copolymer in a suitable solvent (e.g., tetrahydrofuran (THF)).

In the acrylic block copolymer in the art disclosed herein, a monomer (other monomer) other than an alkyl acrylate and an alkyl methacrylate may be copolymerized. Examples of the other monomer include vinyl compounds having functional groups such as alkoxyl group, epoxy group, hydroxyl group, amino group, amide group, cyano group, carboxyl group, acid anhydride group, etc.; vinyl esters such as vinyl acetate; aromatic vinyl compounds such as styrene; vinyl group-containing heterocyclic compounds such as N-vinylpyrrolidone and the like. Alternatively, it can be an alkyl acrylate having a structure with an acryloyl group coupled to a fluorinated alkyl group, a fluorinated alkyl acrylate and a fluorinated alkyl methacrylate. The other monomer may be used, for instance, to adjust the properties (adhesive properties, ease of molding, etc.) of the film and its content is suitably 20% by mass or less (e.g. 10% by mass or less, typically 5% by mass or less) of all the monomers constituting the acrylic block copolymer. In a preferable embodiment, the acrylic block copolymer is essentially free of the other monomers.

Such an acrylic block copolymer can be readily synthesized by a known method (e.g. see JP2001-234146, JPH11-323072), or a commercial product is readily available. Examples of the commercial product include trade name “LA POLYMER” series (e.g., those with product numbers LA2140e, LA2250, etc.) available from Kraray Co., Ltd., trade name “NABSTAR” available from Kaneka Corporation, and the like. As the method for synthesizing the acrylic block copolymer, living polymerization can be preferably employed. According to living polymerization, while keeping the weatherability inherent in the acrylic polymer, because of the excellent structure control unique to the living polymerization, an acrylic block copolymer having excellent thermoplasticity can be synthesized. Since the molecular weight distribution can be controlled in a narrow range, insufficient cohesion caused by the presence of low molecular weight components can be reduced to obtain an easily releasable viscoelastic body (even a film).

When the film in the art disclosed herein comprises an acrylic block copolymer, solely one species or a combination of two or more species of acrylic block copolymer can be used. In addition to the acrylic block copolymer, to control the adhesive properties, etc., it may comprise, as an optional component, a component other than an acrylic block copolymer. Examples of the optional component include a polymer and an oligomer excluding acrylic block copolymers. The amount of the polymer or oligomer (or “optional polymer” hereinafter) is suitably 50 parts by mass or less relative to 100 parts by mass of the acrylic block copolymer, preferably 10 parts by mass or smaller, or more preferably 5 parts by mass or smaller. In a preferable embodiment, the film may be essentially free of polymers other than the acrylic block copolymer.

The resin composition in the art disclosed herein preferably comprises a plasticizer. The inclusion of plasticizer increases the ease of release. It also lowers the viscosity of the composition and thus the film formation is facilitated. In addition, the inclusion of plasticizer increases the sebum absorbing/diffusing ability.

Examples of plasticizer include phthalic acid esters such as dioctyl phthalate, diisononyl phthalate, diisodecyl phthalate, dibutyl phthalate, etc.; adipic acid esters such as dioctyl adipate, diisononyl adipate, etc.; trimellitic acid esters such as trioctyl trimellitate, etc.; sebacic acid esters; and the like. Softeners such as processed oil are also included in the plasticizer. These can be used singly as one species or in a combination of two or more species. Among them, adipic acid esters are preferable.

The amount of plasticizer added is not particularly limited. For instance, it is suitably 1 part by mass or greater to 100 parts by mass of the base polymer (e.g. an acrylic resin). The amount added is preferably 5 parts by mass or greater, more preferably 10 parts by mass or greater, yet more preferably 15 parts by mass or greater, or particularly preferably 20 parts by mass or greater. The amount added is suitably 150 parts by mass or less, preferably 120 parts by mass or less, more preferably 100 parts by mass or less, yet more preferably 70 parts by mass or less, or particularly preferably 50 parts by mass or less. From the standpoint of balancing the sebum absorbing/diffusing ability and other surface protective properties (e.g. scratch resistance, feel to the tough), the amount of plasticizer added is preferably 120 parts by mass or less (e.g. 30 to 120 parts by mass, typically 30 to 100 parts by mass) to 100 parts by mass of the base polymer.

The resin composition (or viscoelastic body, film) in the art disclosed herein can include, as other components, various additives known in the field of surface protection film, such as tackifier, slip agent, surfactant, chain transfer agent, filler (inorganic filler, organic filler, etc.), anti-aging agent, antioxidant, UV ray absorber, photostabilizer, antistatic agent, colorant (pigment, dye, etc.) and so on. The types and amounts of these non-essential additives can be the same as usual types and amounts in this type of film.

When the film is formed from the resin composition disclosed herein, the formation method is not particularly limited. For instance, it is possible to apply a method where the resin composition is directly provided (typically applied) to a flat substrate, using a heretofore known application means such as die coater, gravure roll coater and the like, and allowed to dry. Alternatively, it can be extruded into a film form with a heretofore known extruder to form the film.

The thickness of the film can be suitably selected in accordance with the purpose and is not particularly limited. For instance, the film may have a thickness of 10 μm to 10 mm (e.g. 10 μm to 5 mm, typically 10 μm to 3 mm). From the standpoint of obtaining a sebum absorbing/diffusing ability and film strength, the thickness of the film is preferably about 10 μm or larger, (e.g. 30 μm or larger, typically 50 μm or larger). When it is important to reduce the weight or size, etc., the thickness of the film is preferably 1000 or smaller (e.g. 300 μm or smaller, typically 100 μm or smaller).

At least a first face of the film may be subjected to various heretofore known surface treatments for adhesive strength adjustment such as coating with a silicone-based release agent, making it slippery, etc.

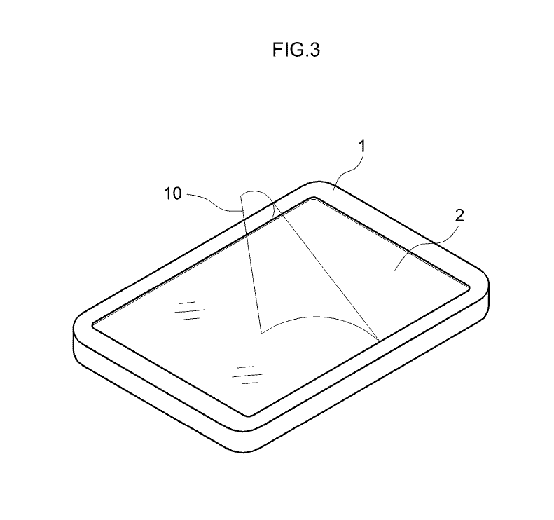

The article to which the film disclosed herein is applied is used in an embodiment where sebum is adsorbed and it is not particularly limited to this extent. Examples include doorknobs, hanging straps, switch covers, keyboard covers, show window glass, glass tables, showcases and the like. Preferable examples of the article to which the film disclosed herein is applied include various portable devices. The portable device herein refers to a mobile device and is not limited to a particular device. Examples include portable devices such as notebook PCs; tablet terminals such as electronic books, etc.; smartphones and other mobile phones; mobile gaming devices; PDAs (mobile terminals) such as electronic organizers, etc.; and the like. Since these are carried and used on a daily basis, they are likely to attract dust and dirt such as finger marks, cosmetics and sebum. Depending on the amount of sebum dirt adsorbed thereon, it might give a filthy impression. Moreover, some of these portable devices have displays such as liquid crystal displays, organic EL displays and the like on glass or synthetic resin surfaces. Sebum dirt on the displays makes information displayed thereon hard to see, thereby hindering the use. On portable devices having such displays, the film disclosed herein can be preferably used. In a preferable embodiment of application of the film disclosed herein, it covers the surface of a touch panel 2 in a tablet terminal 1 as shown in FIG. 3. Such an article (typically an electronic device) having a touch panel display/input portion is touched directly by a user with a finger, and thus is more likely to attract the sebum dirt. Accordingly, the film disclosed herein can be preferably used on such an article. Specific examples of such an article include, besides the aforementioned portable devices, bank ATM (automated teller machine) and so on.

Several working examples related to the present invention are described below although the present invention is not to be limited to these specific examples. In the following explanation, the terms “parts” and “%” are based on the mass unless specifically stated otherwise.

### <Fabrication of Film A>

To a three-neck flask, were placed 2-ethylhexyl acrylate (2EHA) and acrylic acid (AA) at a mass ratio 2EHA:AA=95:5. Toluene was used as the solvent. Under a nitrogen flow, benzoyl peroxide was added as a polymerization initiator. The reaction mixture was heated to 60° C. and the reaction was carried out for 2 hours. The reaction mixture was further heated to 80° C. and the reaction was carried out for 1 hour to prepare a solution of an acrylic resin having a weight average molecular weight (Mw) of about 50×10⁴ to 60×10⁴. Subsequently, to 100 parts of polymeric non-volatiles of the acrylic resin solution, were mixed 30 parts of a plasticizer (diisononyl adipate “MONOCIZER W-242” available from DIC Corporation), 0.1 part of an epoxy-based crosslinking agent (“TETRAD-C” available from Mitsubishi Gas Chemical Inc.) and 2 parts of an isocyanate-based crosslinking agent (“CORONATE L” available from Nippon Polyurethane Industry Co., Ltd.) to prepare an acrylic resin composition. The resulting acrylic resin composition was applied to a flat surface (treated to be releasable) and allowed to age at 50° C. for 24 hours to fabricate Film A having a thickness of about 80 μm.

### <Fabrication of Film B>

A solvent-based acrylic resin composition (available from Nitoms, Inc.) for use in commercial products was applied to a flat surface (treated to be releasable) and allowed to age at 50° C. for 24 hours to fabricate Film B.

### <Fabrication of Film C>

Were mixed 100 parts (non-volatiles) of a commercial acrylic Nock copolymer (thermoplastic acrylic resin A) and 30 parts of a plasticizer (diisononyl adipate “MONOCIZER W-242” available from DIC Corporation) and extruded to fabricate Film C having a thickness of about 50 μm.

### <Fabrication of Film D>

The amount of plasticizer added was increased to 100 parts relative to 100 parts (non-volatiles) of the acrylic resin. Otherwise, in the same manner as Film C, Film D was fabricated.

### <Fabrication of Film E>

Were mixed 100 parts (non-volatiles) of a commercial acrylic Nock copolymer (thermoplastic acrylic resin B) and 30 parts of a plasticizer (diisononyl adipate “MONOCIZER W-242” available from DIC Corporation) and extruded to fabricate Film E having a thickness of about 50 μm.

### [Evaluation of Sebum Absorbing/Diffusing Ability]

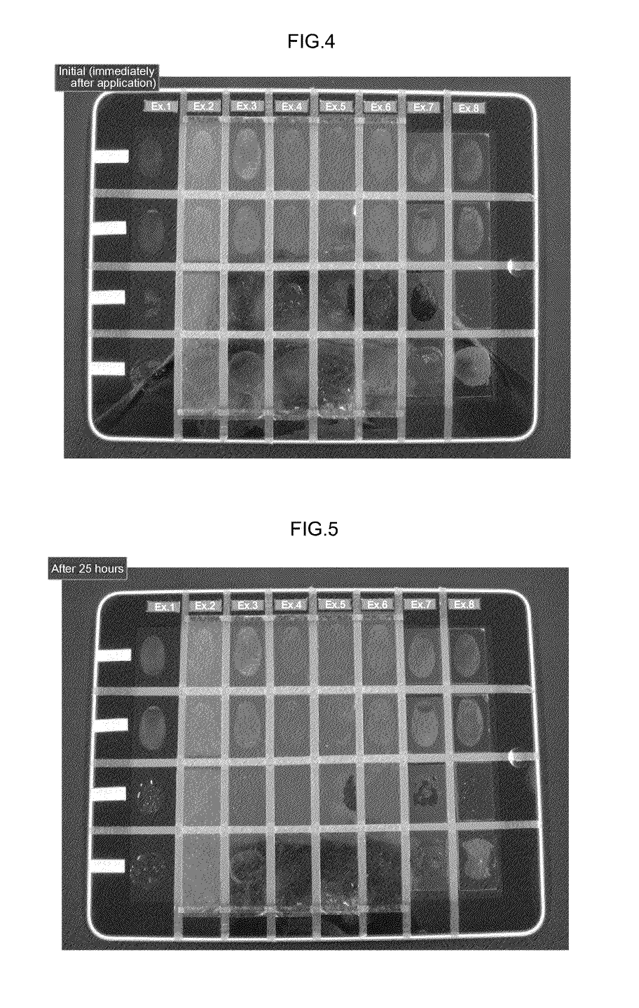

A tablet terminal (iPad®, a product of Apple Inc.) was obtained and the display (flat surface made of aluminosilicate glass) was thoroughly cleaned with a cleaner. Subsequently, the film according to each example was adhered thereto. The films used in the respective examples are as shown in Table 1. Example 1 is a blank, being the exposed adherend surface with no film. Protection films F and G are both commercial tablet terminal protective films advertised as resistant to fingerprint adsorption. Sebum or a sebum substitute was adsorbed to visibly similar levels to the display of the tablet terminal or to the respective films on the display. The resulting terminal was stored in a dry oven at 30° C. The surface states were visually inspected after 25 hours from the adsorption of sebum and evaluated based on the basis indicated below. As the sebum substitute, glycerol monooleate (trade name “RHEODOL MO-60” available from Kao Corporation) was used. The results are shown in Table 1 and FIGS. 4 to 9.

### <Evaluation Basis>

E (excellent): A reduction of sebum adsorbed on the surface is clearly observed.

G (good): A change in the state of sebum adsorbed on the surface and a reduction of sebum are observed.

P (poor): No significant change is observed in the state of sebum adsorbed on the surface.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Film | — | A | B | C | D | E | F | G |
| Absorbing/ | | | | | | | | |
| diffusing | | | | | | | | |
| ability test | | | | | | | | |
| Sebum | P | E | P | G | G | G | P | P |
| Sebum | P | E | P | E | E | E | P | P |
| substitute | | | | | | | | |

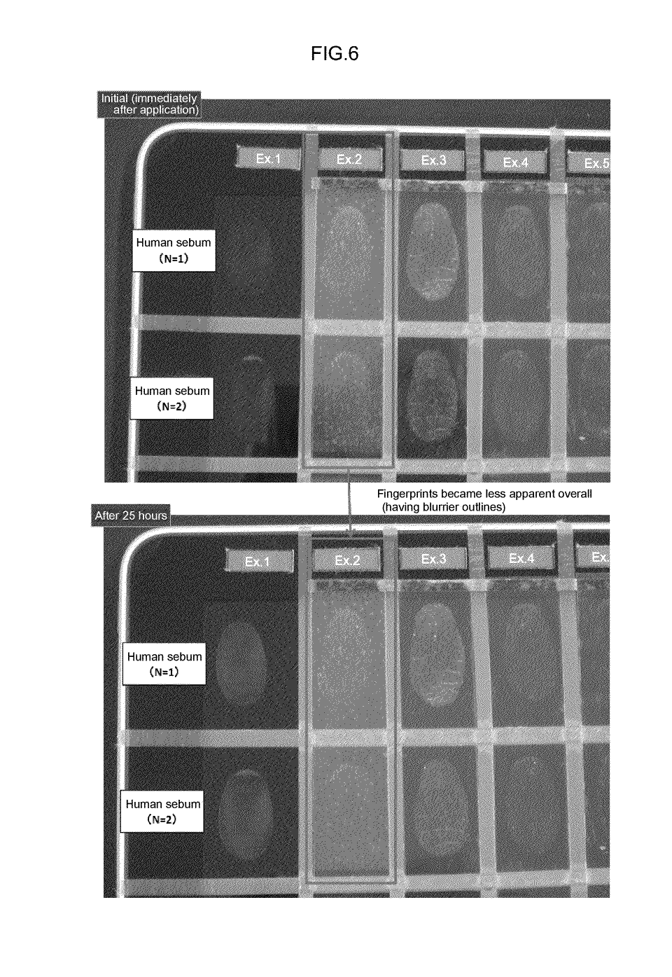

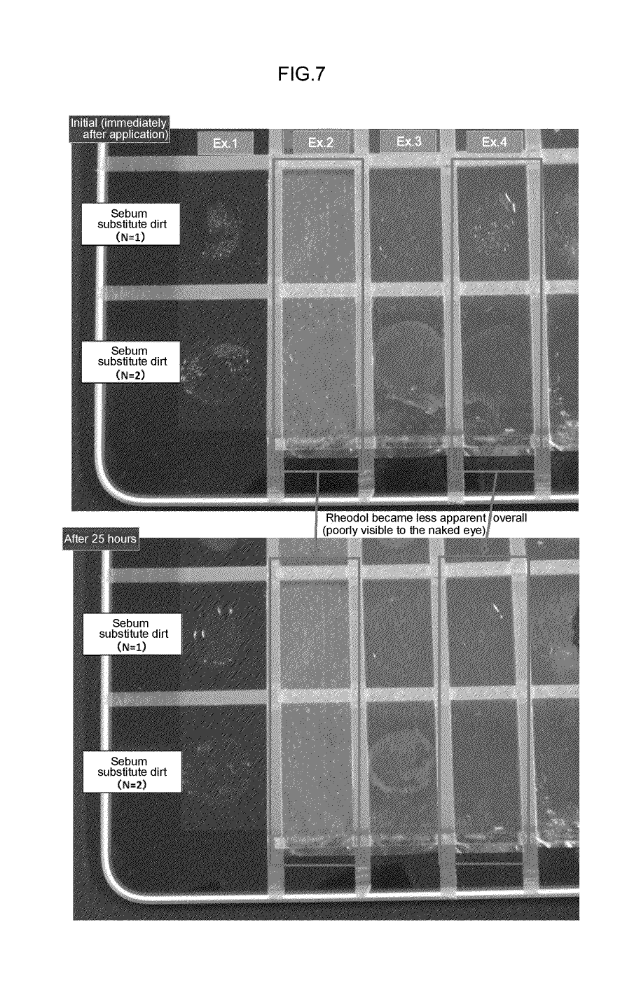

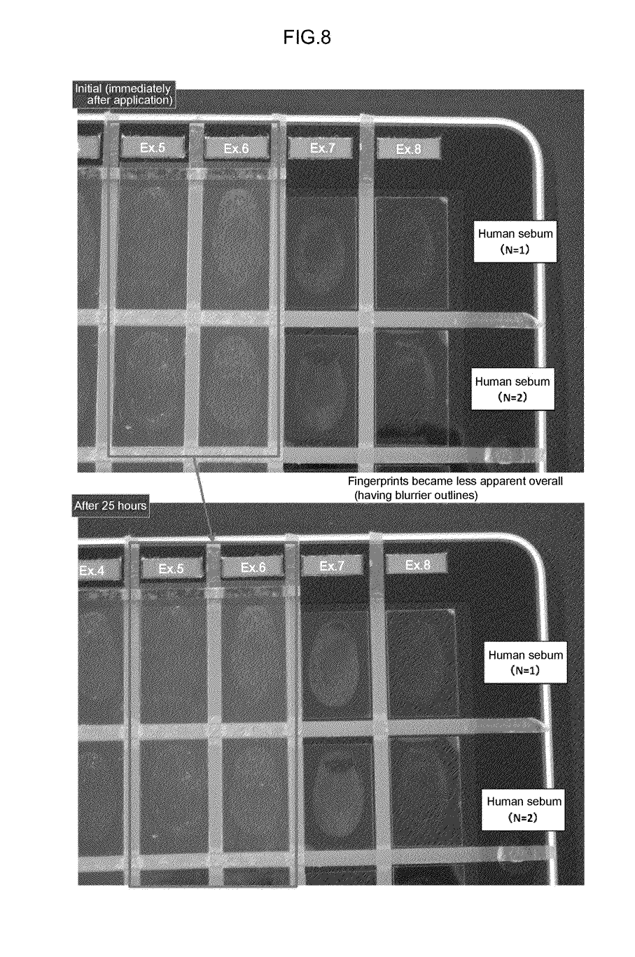

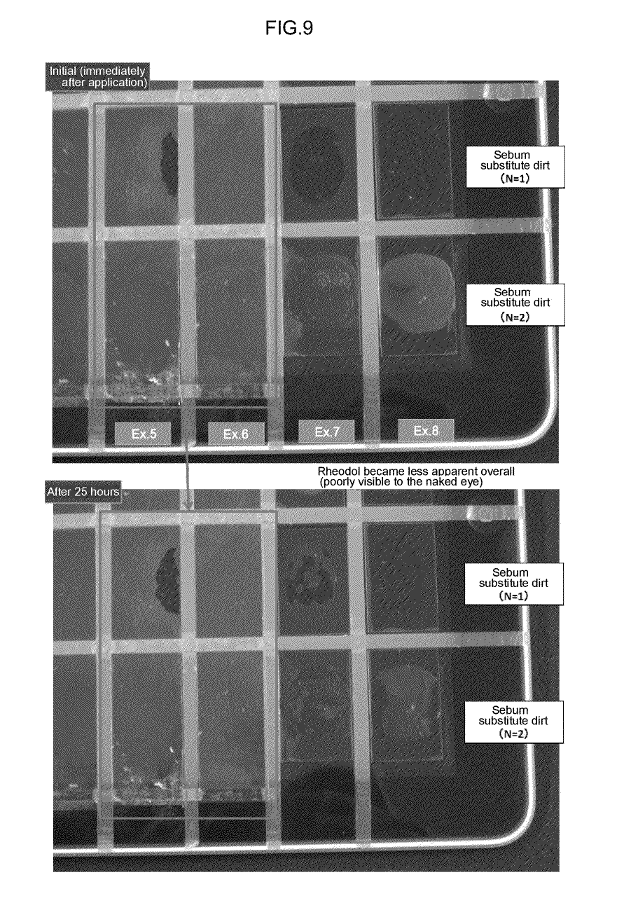

As shown in Table 1, the films according to Examples 2 and 4 to 6 were found to have sebum absorbing/diffusing abilities. On the contrary, the conventional films according to Examples 3, 7 and 8 showed results equivalent to Example 1 with no film and no sebum absorbing/diffusing abilities were observed. More specifically, in the images in FIGS. 4 to 9, especially as shown in FIG. 6, with respect to the film according to Example 2, a reduction of sebum was clearly observed on the film surface in comparison with adjacent Examples 1 and 3. Especially as shown in FIG. 7, with respect to the films according to Examples 2 and 4, reductions of the sebum substitute were clearly observed on the film surfaces in comparison with adjacent Examples 1 and 3. In addition, especially as notable in FIG. 9, with respect to the films according to Examples 5 and 6, reductions of the sebum substitute were clearly observed on the film surfaces in comparison with Examples 7 and 8. Similar tendencies were observed when sebum was used (FIG. 8).

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1 article (tablet terminal)
1A surface (of an article)
2 touch panel
10 sebum absorption/diffusion film (film)
10A surface (of film)
20 sebum

1. A protector comprising a film being capable of absorbing sebum adsorbed on a surface of the film into the film and of allowing the sebum absorbed to diffuse inside the film.

2. The protector according to claim 1, wherein the film has a haze value of 10% or lower.

3. The protector according to claim 1, wherein the film comprises an acrylic resin.

4. The protector according to claim 3, wherein the acrylic resin is a thermoplastic acrylic resin.

5. The protector according to claim 3, wherein the acrylic resin is a crosslinked acrylic resin.

6. The protector according to claim 3, wherein the film comprises a plasticizer at a ratio of 5 to 150 parts by mass relative to 100 parts by mass of the acrylic resin.

7. The protector according to claim 1 used for protecting a display in a portable device.

8. An article having the protector according to claim 1, wherein the article has a surface covered with the protector.

9. A portable device having the protector according to claim 1, wherein the article has a touch panel display/input portion on a surface, and the surface is covered with the protector.
